(19) United States
(12) Patent Application Publication
(10) Pub. No.: US 2017/0136849 A1
(43) Pub. Date: May 18, 2017

(54) WATER TANK COVER FOR A MOTOR VEHICLE

(71) Applicant: GM GLOBAL TECHNOLOGY OPERATIONS LLC, Detroit, MI (US)

(72) Inventors: Fabian KEMPFER, Ruesselsheim (DE); Younes CHLYEH, Ruesselsheim (DE)

(73) Assignee: GM GLOBAL TECHNOLOGY OPERATIONS LLC, Detroit, MI (US)

(21) Appl. No.: 15/348,461

(22) Filed: Nov. 10, 2016

(30) Foreign Application Priority Data
Nov. 12, 2015 (DE) 102015014646.7

(51) Int. Cl. B60H 1/28

(52) U.S. Cl. CPC B60H 1/28

(57) ABSTRACT

The present disclosure relates to a water tank cover for a motor vehicle, which has at least one air entry area for the supply of fresh air for a vehicle interior. The at least one air entry area is formed by a plurality of openings in the water tank cover, which exhibit a continuous edge that is elevated relative to an outer surface of the water tank cover.

### CROSS-REFERENCE TO RELATED APPLICATION

This application claims priority to German Patent Application No. 102015014646.7, filed Nov. 12, 2015, which is incorporated herein by reference in its entirety.

### TECHNICAL FIELD

The present disclosure pertains to a water tank cover for a motor vehicle with at least one air entry area for the supply of fresh air for a vehicle interior.

### BACKGROUND

Motor vehicles usually exhibit a water tank that serves primarily to discharge gushing water flowing along the windshield of a motor vehicle, for example during heavy rainfall. The water tanks can also be used to separate water out of a supply of fresh air for a vehicle interior. Such a water tank then simultaneously also serves as an air intake tank. The fresh air is diverted to separate out the water inside of the water tank.

Known from DE 10 2007 017 427 A1 is a motor vehicle with a water tank situated below a gap between the windshield and hood. The water tank is covered at the top by an oblong water tank cover. The water tank cover has a groove running in the transverse direction of the vehicle for laterally discharging water.

### SUMMARY

In accordance with the present disclosure a water tank cover for a motor vehicle is provided for ensuring as dry a water tank as possible even during heavy rainfall. In an embodiment of the present disclosure, the water tank cover includes at least one air inlet area for the supply of fresh air for a vehicle interior. The air inlet area is here formed by a plurality of openings in the water tank cover, which exhibit a continuous edge that is elevated relative to an outer surface of the water tank cover. Because the at least one air inlet area of the water tank cover through which fresh air can be supplied to the vehicle interior is formed by a plurality of openings in the water tank cover with an elevated continuous edge, water flowing down from the windshield can be prevented from entering into the water tank through the openings. As a result, less water can get into the water tank through these openings. In this way, wetness and moisture in the airway of the fresh air supply can be diminished, so that a filter, for example a pollen filter, located in the airway can stay dry. This in turn prevents the windows of the motor vehicle from getting sprayed from inside during the corresponding supply of fresh air. In addition, mechanical and electrical components located in the airway, for example a fan, a fan regulator or a windshield wiper motor, do not get moist or wet, making the latter less susceptible to corrosion or malfunction. As a consequence, the driest possible water tank can be ensured even given heavy rainfall.

The openings can here be formed and arranged in the water tank cover in such a way that water hitting the outer surface of the water tank cover is discharged laterally in the direction of an end of the water tank cover designed like a body side connecting region by the elevated, continuous edges of the openings. In particular, the dimensions, shapes and arrangements of the individual openings and/or the positioning of the individual openings relative to each other can be selected in such a way that water hitting the water tank cover, for example water flowing in from the windshield, can be efficiently and specifically discharged outwardly from the air inlet area in the direction of the end of the water tank cover designed like a body side connecting region.

In addition, the individual openings can each be covered by a grid, which prevents leaves or other objects from getting into the water tank through the openings in the water tank cover.

Furthermore, the water tank cover can be downwardly inclined relative to the end designed as a body side connecting region, thereby making it possible to strengthen even more the effect in which the water hitting the water tank cover, for example water flowing in from the windshield, is efficiently and specifically discharged outwardly from the air inlet area in the direction of the end of the water tank cover designed like a body side connecting region. In particular, water flowing in from the windshield can be prevented from accumulating on the water tank cover. For example, the water tank cover can here exhibit its highest location in the vertical direction in roughly the middle.

Another embodiment of the present disclosure also indicates a water tank for a motor vehicle that exhibits a water tank cover described above. The advantage to such a water tank is that the latter remains largely dry even during heavy rainfall. Because the at least one air inlet area of the water tank cover through which the vehicle interior can be supplied with fresh air is formed by a plurality of openings in the water tank cover with an elevated, continuous edge, water flowing down from the windshield can be prevented from entering into the water tank through the openings. As a result, less water can get into the water tank through these openings. In this way, wetness and moisture in the airway of the fresh air supply can be diminished, so that a filter, for example a pollen filter, located in the airway can stay dry. This in turn prevents the windows of the motor vehicle from getting sprayed from inside during the corresponding supply of fresh air. In addition, mechanical and electrical components located in the airway, for example a fan, a fan regulator or a windshield wiper motor, do not get moist or wet, making the latter less susceptible to corrosion or malfunction.

Another embodiment also indicates a motor vehicle that exhibits such a water tank. As a consequence, the advantage to such a motor vehicle is that it has a water tank that remains largely dry even during heavy rainfall. This in turn prevents the windows of the motor vehicle from getting sprayed from inside during the corresponding supply of fresh air via the water tank. In addition, mechanical and electrical components located in the airway, for example a fan, a fan regulator or a windshield wiper motor, do not get moist or wet, making the latter less susceptible to corrosion or malfunction.

In summation, it must be noted that the present disclosure indicates a water tank cover for a motor vehicle that can ensure as dry a water tank as possible even during heavy rainfall. Because the at least one air inlet area of the water tank cover through which fresh air can be supplied to the vehicle interior is formed by a plurality of openings in the water tank cover with an elevated continuous edge, water flowing down from the windshield can be prevented from entering into the water tank through the openings. This in turn allows less water to get into the water tank through these openings.

The openings can here be formed and arranged in the water tank cover in such a way that water hitting the water tank cover, for example water flowing in from the windshield, can be efficiently and specifically discharged outwardly from the air inlet area in the direction of the end of the water tank cover designed like a body side connecting region.

### BRIEF DESCRIPTION OF THE DRAWINGS

The present disclosure will hereinafter be described in conjunction with the following drawing figures, wherein like numerals denote like elements.

FIG. 1 shows a schematic, perspective view of a water tank cover for a motor vehicle according to embodiments of the present disclosure.

### DETAILED DESCRIPTON

The following detailed description is merely exemplary in nature and is not intended to limit the invention or the application and uses of the invention. Furthermore, there is no intention to be bound by any theory presented in the preceding background of the invention or the following detailed description.

Motor vehicles usually exhibit a water tank, which serves primarily to discharge gushing water flowing along the windshield 2 of a motor vehicle, for example during heavy rainfall. These water tanks can also be used to separate water out of a supply of fresh air for a vehicle interior. Such a water tank then simultaneously also serves as an air intake tank, wherein the fresh air is diverted to separate out the water inside of the water tank.

A motor vehicle typically has an end wall for separating a motor area from a vehicle interior. The upper region of the latter has a part that protrudes opposite the longitudinal direction of the motor vehicle, i.e., to the front toward the front side of the motor vehicle, and is also referred to as the upper front end wall. On the one hand, the latter provides a transverse reinforcement, which is why it is also fastened to the spring-strut dome. It also serves as a bracket for various components, such as a windshield wiper linkage and a windshield wiper motor. These components are located in the area of the motor vehicle referred to as the water tank, which is formed by the upper end wall, the upper front end wall, and potentially a service panel. The water tank is thus located below a gap between the windshield and hood. To provide protection against dirt and in particular water, for example water flowing from the windshield, the water tank is covered at the top by the water tank cover 1, which often is also referred to as a water deflector.

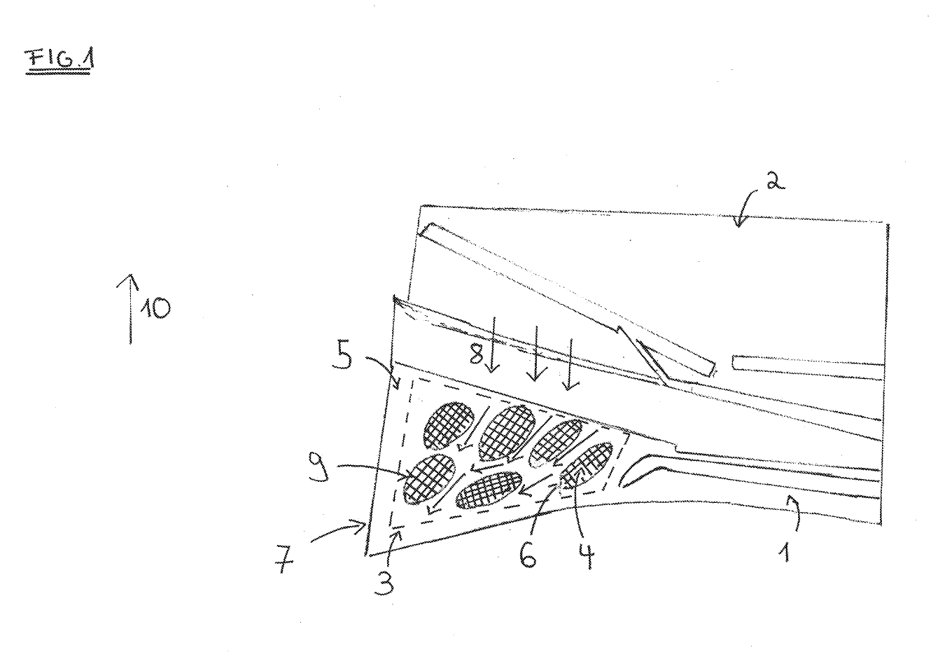

With reference to FIG. 1, a water tank cover 1 for a motor vehicle is illustrated. In order to supply fresh air into the vehicle interior, which is processed accordingly in the water tank and then routed into the vehicle interior, such a water tank cover 1 usually incorporates at least one air inlet area, wherein an air inlet area is denoted on FIG. 1 by a dashed area marked with reference number 3. The air inlet area 3 is here formed by a plurality of openings 4 in the water tank cover 1, which exhibit a continuous edge 6 that is elevated relative to an outer surface 5 of the water tank cover 1. The outer surface 5 of the water tank cover 1 is understood as the surface of the water tank cover 1 hit by the gushing water flowing along the windshield 2 of the motor vehicle, for example during heavy rainfall.

Because the at least one air inlet area 3 of the water tank cover 1 through which fresh air can be supplied to the vehicle interior is formed by a plurality of openings 4 in the water tank cover 1 with an elevated continuous edge 6, water flowing down from the windshield can be prevented from entering into the water tank through the openings, so that the driest possible water tank can be ensured even given heavy rainfall.

As further shown on FIG. 1, the openings 4 in the water tank cover 1 are here formed and arranged in such a way that water hitting the outer surface 5 of the water tank cover 1 is discharged laterally in the direction of an end 7 of the water tank cover 1 designed like a body side connecting region by the elevated, continuous edges 6 of the openings 4.

In particular, the dimensions, shapes and arrangements of the individual openings 4 and/or the positioning of the individual openings 4 relative to each other can be selected in such a way that water hitting the water tank cover 1, for example water flowing in from the windshield 2, can be efficiently and specifically discharged outwardly from the air inlet area 3 in the direction of the end 7 of the water tank cover 1 designed like a body side connecting region, wherein the direction of flow of the water on FIG. 1 is symbolized by the arrows marked with reference number 8.

As further shown on FIG. 1, the individual openings 4 are each also covered by a honeycomb grid 9, so as to prevent leaves or other objects from getting into the water tank through the openings 4.

As further evident, the water tank cover is downwardly inclined relative to the end 7 designed as a body side connecting region, thereby making it possible to strengthen even more the effect in which the water hitting the water tank cover 1, for example water flowing in from the windshield, is efficiently and specifically discharged outwardly from the air inlet area 3 in the direction of the end 7 of the water tank cover 1 designed like a body side connecting region. In particular, this is accomplished by virtue of the fact that the water tank cover 1 has its highest point relative to a yaw axis of the motor vehicle in the area of the vehicle middle, and a water outlet opening on the end 7 designed as a body side connecting region that enables a controlled discharge of water represents the lowest point. The yaw axis of the motor vehicle is here symbolized by the arrow marked with reference number 10 on FIG. 1.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-6. (canceled)

7. A water tank cover for a motor vehicle comprising at least one air entry area for the supply of fresh air for a vehicle interior, wherein the at least one air entry area is formed by a plurality of openings in the water tank cover and a continuous edge that is elevated relative to an outer surface of the water tank cover.

8. The water tank cover according to claim 7, wherein the openings in the water tank cover are formed and arranged in such a way that water hitting the outer surface of the water tank cover is discharged laterally in the direction of an end of the water tank cover designed like a body side connecting region by the elevated, continuous edges of the openings.

9. The water tank cover according to claim 8, wherein the water tank cover is downwardly inclined relative to the end designed as a body side connecting region.

10. The water tank cover according to claim 8, wherein the openings are each covered by a grid.

11. The water tank cover according to claim 10, wherein the water tank cover is downwardly inclined relative to the end designed as a body side connecting region.

12. The water tank cover according to claim 10, wherein the openings are each covered by a grid.
